(19) United States
(12) Patent Application Publication
(10) Pub. No.: US 2017/0175055 A1
(43) Pub. Date: Jun. 22, 2017

(54) AUTOMATIC DISHWASHING COMPOSITION

(71) Applicant: The Procter & Gamble Company, Cincinnati, OH (US)

(72) Inventors: Philip Frank SOUTER, Northumberland (GB); Alan Thomas BROOKER, Newcastle upon Tyne (GB); Nigel Patrick SOMERVILLE-ROBERTS, Newcastle upon Tyne (GB); Philip Andrew CUNNINGHAM, Vossem (BE); Martin James PEACOCK, Newcastle upon Tyne (GB); Lindsay Suzanne BEWICK, Newcastle upon Tyne (GB)

(21) Appl. No.: 15/376,690

(22) Filed: Dec. 13, 2016

(30) Foreign Application Priority Data
Dec. 22, 2015 (EP) 15202207.5

(51) Int. Cl. C11D 11/00; C11B 9/00; C11D 3/20; C11D 3/39; C11D 3/50; C11D 17/04

(52) U.S. Cl. CPC C11D 11/0023; C11D 3/50; C11D 17/042; C11D 17/045; C11D 3/2082; C11D 3/3942; C11B 9/0019

(57) ABSTRACT

A neutral or acidic automatic dishwashing detergent composition including a perfume wherein the perfume includes at least one ester-including perfume raw material having the following formula:

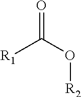

wherein R1 and R2 are independently selected from:
i) unbranched linear alkyls or alkenyls; and
ii) branched linear alkyls or alkenyls wherein if the branching is in an alpha or beta position the branching is CH3 or a pendant cyclic group.

### TECHNICAL FIELD

The present invention is in the field of automatic dishwashing. In particular it relates to a composition that is able to provide effective cleaning, shine, malodour control and freshness.

### BACKGROUND OF THE INVENTION

Traditionally automatic dishwashing products comprise a perfume. Said perfume is present to provide a pleasant smell to the product. Items to be cleaned in an automatic dishwashing machine are soiled with food residues. The nature of the residues is quite diverse depending on the food that has been deposited on or cooked in the dishware/tableware. Usually the food residues have a plurality of malodours associated to them. Malodours can also come from food residues accumulated in dishwasher's parts such as the filter. The filter is usually a wet environment with food residues prone to bacteria degradation that usually have malodours associated to it.

The malodours can become evident during the automatic dishwashing operation either because there is superposition or combination of malodours that in terms give rise to other malodours and/or because the high temperature and humidity conditions found during an automatic dishwashing operation contribute to an easier perception of the malodours. Malodours can also be evident upon loading the dishwasher, especially if food residues degrade or rot.

Automatic dishwashing machines are usually placed in kitchens where users cook and frequently eat and they do not like to have unpleasant odours coming from the automatic dishwashing machine.

An automatic dishwashing composition should provide effective cleaning, shine, malodour control and a pleasant freshness. A high level of cleaning helps both clean the items within the dishwasher (plates, cutlery, glasses, cooking dishes etc.) and good cleaning of the dishwasher itself, including the filter and other parts of the dishwasher. By achieving a good level of cleaning of the dishwasher, this reduces the amount of food residues and hence the amount of malodour that needs to be masked by a perfume. The perfume needs to provide three key functions:
(a) good smell to the product per se;
(b) good smell in the dishwasher; and
(c) reduce or eliminate the malodours that are generated during an automatic dishwashing process and to substitute the malodours by a pleasant fragrance in the area surrounding the dishwasher during use and in between uses.

### SUMMARY OF THE INVENTION

According to a first aspect of the invention there is provided an automatic dishwashing composition that is able to provide effective cleaning, shine, malodour control and freshness.

Typical automatic dishwashing products are formulated such that a 1% solution of the product has a pH of between 9 and 11.5. This is because in order to effectively clean the items found within the dishwasher and minimize the number of residues found in the machine filter, an automatic dishwashing product is formulated at high pH in order to effectively hydrate and swell soils, provide a pH range in which bleaches are effective (the hydroperoxide anion is a valuable bleaching species, either on its own or as a means to perhydrolyze a bleach activator such as TAED) and a pH in which triglyceride grease soils are effectively hydrolyzed.

Such compositions are well optimized to provide cleaning but there is a clear tension between this cleaning and providing:
(a) optimum freshness and malodour control; and
(b) providing excellent shine.

At such high pHs, a significant quantity of insoluble calcium salts can be formed that lead to inorganic filming on items such as glasses, cutlery and plastic, particularly when the items are subjected to multi-cycles. This effect can be mitigated by use of strong soluble calcium builders such as MGDA and GLDA, although these represent an expensive solution to this problem. Beyond this, there are many perfume raw materials that are not stable under wash conditions and consequently it is not possible to provide a product that simultaneously delivers outstanding cleaning, shine, malodour control and freshness.

Typical automatic dishwashing products formulated such that a 1% solution of the product has a pH of between 9 and 11.5 can present perfume stability issues, in particular when the perfume comprises certain esters and/or sulphur containing perfume raw materials. It has surprisingly been found that contrary to what it is believed, neutral or acidic automatic dishwashing detergent compositions provides very good cleaning and shine and at the same time good malodour control and freshness.

By neutral or acidic composition is herein understood a composition that in a 1% solution in distilled water at 25° C. has a pH of from 5 to 9, preferably from 5.5 to 8, more preferably from 6 to 7.

By “ester-comprising perfume raw material” is herein understood a perfume component comprising an ester functionality. An ester-comprising perfume raw material includes single molecules, reaction mixtures, bases/specialties/premixes (i.e. a sub formulation which is mixed together and added to form the final perfume), naturals ingredients, etc.

The ester-comprising perfume raw materials of the composition of the invention are sometimes herein referred to as “the esters of the invention”.

The esters of the invention have the following formula:

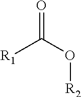

wherein R1 and R2 are independently selected from:
i) unbranched linear alkyls or alkenyls; and
ii) branched linear alkyls or alkenyls wherein if the branching is in an alpha or beta position the branching is CH3 or the branching is a pendant cyclic group.

Without being bound by theory, it is believed that the esters of the invention exhibit poor stability in typical automatic dishwashing compositions and in the automatic dishwashing process and that their improved performance in the compositions of this invention is driven by superior stability. The ester functionality of the esters of the invention is not sterically hindered in the cases in which R1 and R2 are independently selected from:
i) unbranched linear alkyls or alkenyls; and
ii) branched linear alkyls or alkenyls wherein if the branching is in an alpha or beta position the branching is methyl.

In the case of R1 and/or R2 being a pendant cyclic group, the ester bond seems to open making the ester functionality more prone to hydrolysis.

Preferably, in the esters of the invention R1 and R2 are independently selected from:
i) unbranched linear alkyls or alkenyls; and
ii) branched linear alkyls or alkenyls wherein if the branching is in an alpha or beta position the branching is a pendant cyclic group.

The perfume of the composition of the invention comprises at least 3%, preferably at least 5%, more preferably from 5 to 50% by weight of the perfume of ester-comprising perfume raw material. Preferably, the composition of the invention comprises from 0.1 to 5%, more preferably from 0.2 to 2% of perfume by weight of the composition.

Preferably, the perfume comprises a sulphur-comprising perfume raw material, preferably selected from the group consisting of oxane, furfuryl methyl sulphide, dipropyl sulphide, dibutyl sulphide, 1,8-thiocineol, dimethyl sulphide, p-menth-1-en-8-thiol, thiomenthone, tropicol and mixtures thereof. These sulphur-comprising perfume raw materials are not very stable at alkaline conditions. Preferably, the perfume comprises from 0.1 to 10%, more preferably from 1 to 8% by weight of the perfume of sulphur-comprising perfume raw material.

The perfume would typically comprises at least about 10%, more preferably at least about 20% and especially at least 30% by weight of the perfume of blooming perfume ingredients having a boiling point of less than 260° C. and a C log P of at least 3. The perfume would also typically comprise non-blooming perfume ingredients having a boiling point of more than 260° C. and a C log P of at least 3, preferably less than about 30%, more preferably less than about 25% and preferably between 5 and 20% by weight of the perfume of non-blooming perfume ingredients.

The perfume compositions of the method of the present invention are very effusive and consumer noticeable, leaving minimal residual perfume on the washed items, including dishes, glasses and cutlery, especially those made of plastic, rubber and silicone. The compositions can leave a residual perfume in the automatic dishwashing machine that can be enjoyed by the user in between dishwashing operations and mitigate any malodour from residual soils in the machine filter.

A blooming perfume ingredient is characterized by its boiling point (B.P.) and its octanol/water partition coefficient (P). The octanol/water partition coefficient of a perfume ingredient is the ratio between its equilibrium concentrations in octanol and in water. Since the partition coefficients of the preferred perfume ingredients herein have high values, they are more conveniently given in the form of their logarithm to the base 10, log P. The B.P. herein is determined at the normal, standard pressure of 760 mm Hg.

c Log P: The c Log P of a perfume component is determined in accordance with the protocol described in U.S. Pat. No. 6,916,769.

Preferably, the composition of the invention is “substantially builder-free”. For the purpose of this invention a “substantially builder-free composition” is a composition comprising less than 10%, preferably less than 5%, more preferably less than 1% and especially less than 0.1% by weight of the composition of builder. Builders are cleaning actives widely used in automatic dishwashing detergents, in particular in alkaline compositions. Most, if not all, of the automatic dishwashing detergents available in the market are alkaline and comprise builders. Compounds that would act as builder under alkaline conditions would probably not be good builders under the low pH conditions of the composition of the invention. Builders can sequester calcium and other ions, from soils and from water greatly contributing to cleaning. The downside of using builders is that they can precipitate and give rise to filming and spotting on the washed items. The formulation approach used in the composition of the present invention overcomes the filming and spotting issues. The washed items, in particular, glass items are left clear and shiny.

The soils brought into the wash liquor during the automatic dishwashing process can greatly alter the pH of the wash liquor. In order to provide optimum cleaning the pH of the wash liquor should not vary too much. This is achieved with the composition of the present invention by the presence of a buffer that helps to keep the pH of the wash liquor within a desired range.

The composition of the invention comprises a buffer. By “buffer” is herein meant an agent that when present in a wash liquor is capable of maintaining the pH of the liquor within a narrow range. By a “narrow range” is herein meant that the pH changes by less than 2 pH units, more preferably by less than 1 pH unit.

Preferably the buffer comprises an organic acid, preferably a carboxylic acid and more preferably the buffer is selected from a polycarboxylic acid, its salt and mixtures thereof.

Preferably, the composition of the invention comprises an iron chelant. Compositions comprising an iron chelant provide good cleaning of bleachable stains, even in the absence of bleach or with low level of bleach. Without being bound by theory, it is believed that the iron chelant removes heavy metals that form part of bleachable stains, thereby contributing to the loosening of the stain. The stain tends to detach itself from the soiled substrate. The cleaning can be further helped by the presence of a performance polymer, preferably a dispersing polymer that would help with the suspension of the stain. Under the low pH conditions provided by the compositions of the invention, when the heavy metals are taken from the bleachable stain, the stain can become more particulate in nature and the polymer can help with suspension of the stain. Preferred iron chelants for use herein have been found to be disodium catecholdisulfonate and hydroxypyridine N-Oxides, in particular disodium catecholdisulfonate.

Preferably, the composition of the invention comprises a lime soap dispersing agent. The lime soap dispersing agent preferably provides swelling of the soil, in particular greasy soils. The composition of the invention preferably comprises an amylase, more preferably a low temperature amylase. It seems that the amylase and the lime soap dispersant agent work in synergy to provide very good cleaning and shine. Without being bound by theory it is believed that the lime soap dispersing agent keeps the soil, especially greasy soils, suspended leaving the starchy part of soils exposed facilitating the access of the amylase to the starch. Preferred lime soap dispersing agents for use herein are surfactants, preferably anionic surfactants and/or performance polymers, preferably dispersant polymer especially an alkoxylated polyalkyleneimine.

It has also been found that bleach present in the composition of the invention provides a bleaching benefit much greater than expected. It has also been found that the bleaching occurs faster and at lower temperatures than using conventional alkaline detergents. Without being bound by theory, it is believed that the iron ions present into the wash liquor (brought by soils, such as tea, beef, etc., impurities in detergent components and/or water) act as catalyst for the bleach to generate bleaching radicals. This effect is most pronounced when an iron chelant is used and it is believed that this is the case because the iron chelant binds the iron to generate metal catalysts in situ that when combined with the bleach are able to drive excellent bleach cleaning.

The cleaning provided by the compositions of the invention is further improved when the composition comprises a crystal growth inhibitor, in particular HEDP.

The performance provided by the compositions of the invention can be further improved by anionic surfactant. When the composition comprises anionic surfactant, the use of a suds suppressor is preferred. Anionic surfactants can generate suds during the automatic dishwashing process however the suds generation with the composition of the invention is less than the suds generation under alkaline conditions, thus the level of suds suppressor required is lower than what it would be for an alkaline composition.

Preferred compositions further comprise proteases. In particular proteases selected from the group consisting of:
(i) a metalloprotease;
(ii) a cysteine protease;
(iii) a neutral serine protease;
(iv) an aspartate protease, and
(v) mixtures thereof.

These proteases perform well in the low pH composition of the invention. Some of the proteases present in conventional alkaline detergents do not perform well at the pH of the composition of the invention. Also preferred are endoproteases, preferably those with an isoelectric point of from about 4 to about 9 and more preferably from about 4.5 to about 6.5. Compositions comprising proteases having these isoelectric points perform very well in the low pH compositions of the invention.

The compositions of the invention is so effective that only a low level needs to be used in the dishwasher to provide outstanding results thereby allowing for very compact compositions. The composition of the invention is preferably used in a weight per wash of from about 5 to about 25 grams, more preferably from about 7 to about 20 grams and especially from about 7 to about 15 grams.

### DETAILED DESCRIPTION OF THE INVENTION

The present invention envisages a neutral or acidic automatic dishwashing detergent composition comprising a perfume comprising at least one ester-comprising perfume raw material. The composition provides good cleaning, shine, malodour control and freshness.

### Perfume

The perfume of the composition of the invention comprises an ester having the following formula:

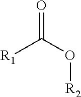

wherein R1 and R2 are independently selected from:
i) unbranched linear alkyls or a unbranched linear lkenyls; and
ii) branched linear alkyls or alkenyls wherein if the branching is in an alpha or beta position the branching is CH3 or a pendant cyclic group, preferably a pendant cyclic group.

The alpha-position is defined as the closest carbon in groups R1 and R2 to the ester group. The beta-position is one carbon further removed down the organic chain and the gamma position is two carbons further down the organic chain.

Perfumes comprising the esters of the invention can be ineffective in typical automatic dishwashing formulations but are very effective in the composition of the invention.

Preferred esters for use herein are selected from the group consisting of: isopropyl 2-methylbutyrate, hexyl isobutyrate, hexyl butyrate, ethyl 2 methyl pentanoate, hexyl acetate, hexyl propanoate, ethyl 2-methylbutyrate, butyl butyrate, amyl propionate, ethyl hexanoate, methyl 2-methylbutyrate, ethyl acetate, isoamyl acetoacetate, geranyl acetate, isoamyl acetate, linalyl acetate, ethyl butyrate, citronellyl acetate, benzyl acetate, cis-3-hexenyl acetate, 3-hexenyl acetate, ethyl acetoacetate, neryl acetate, prenyl acetate, tetrahydrolinalyl acetate, hexyl octanoate, ethylene brassylate, isobutyl caproate, ethyl laurate, hexyl 2-methylbutanoate, Hexyl hexanoate, Octyl acetate, Isobutyl acetate, n-Pentyl butyrate, Butyl acetate, Isobutyl angelate, Ethyl propionate, Hexyl tiglate, Pear Ester, Ethyl 2-phenylacetate, Phenethyl 2-methylbutyrate, Methyl phenylacetate, Ethylmethylphenylglycidate, Linalyl isobutyrate, Nopyl acetate, cis-3-Hexenyl valerate, Citronellyl phenylacetate, (Z)-3-hepten-1-yl acetate, p-methylbenzyl acetate, cis-3-Hexenyl butyrate, Benzyl propionate, Linalyl butyrate, Linalyl propionate, Phenethyl phenylacetate, Phenethyl tiglate, cis-3-Hexenyl tiglate, cis-3-hexenyl-cis-3-hexenoate, Lavandulyl acetate, Neryl isobutyrate, Geranyl isobutyrate, Geranyl caprylate, Geranyl hexanoate, Geranyl valerate, Geranyl butyrate, Geranyl propionate, Geranyl phenylacetate, Geranyl phenyl acetate, Geranyl tiglate, Fruitate, Cedryl acetate, Acetoxymethyl-isolongifolene (isomers), Isobornyl isobutyrate, Bornyl isobutyrate, Cyprisate Ci, Isomenthyl acetate, dl-Menthyl acetate, (+)-D-Menthyl acetate, Isopropyl palmitate, Serenolide, Dihydrocyclacet, 1,3,3-trimethyl-2-norbornanyl acetate, Isobornyl acetate, Bornyl acetate, Isobornyl propionate, Butyl stearate, Alicate, Dihydro-alpha-terpinyl acetate, Koumalactone, Alpinofix, Rosamusk, Isoamyl laurate, Isopropyl myristate, Hexyl Neopentanoate, Hexadecanolide, alpha-acetoxystyrene, Methyl Laitone, Exaltolide, Dimethyl Octanyl Acetate, Amber acetate, Isopropyl dodecanoate, Thesaron, Peacholide, Helvetolide, delta-Dodecalactone, Methyl stearate, 3,6-Dimethyl-3-octanyl acetate, Ethyl palmitate, gamma-Dodecalactone, Isoamyl octanoate, Ethyl 2-(cyclohexyl)propionate, Isoamyl isobutyrate, Lactojasmone, Spirolide, Isononyl acetate, delta-Undecalactone, Datilat, Methyl Octalactone, gamma-Undecalactone (racemic), (S)-gamma-Undecalactone, (R)-gamma-Undecalactone, Octahydrocoumarin, Cyclohexylethyl acetate, Lauryl acetate, Methyl hexadecanoate, Ethyl myristate, Undecanolide, delta-Decalactone, gamma-Decalactone, Pivacyclene, Vanoris, Cyclohexyl acetate, Oxalide, Musk R1, gamma-Nonalactone, Cervolide, Jasmal, Methyl myristate, Frutinat, Parsol MCX, Nonalactone, Cyclic ethylene dodecanedioate, Clarycet, gamma-Octalactone, Isopentyl butyrate, Decyl propionate, Romanolide, Methyl Camomille, gamma-Heptalactone, Isopentyl propanoate, Ethyl decanoate, Fructalate, gamma-Valerolactone, Vetikol acetate, Heptyl acetate, gamma-Hexalactone, Ethyl nonanoate, Ethyl isovalerate, Amyl Cinnamate, Pentanoic acid, 2-methyl-, ethyl ester, (S)-, Ethyl octanoate, Ethyl isobutanoate, Ethyl heptoate, n-Pentyl acetate, n-Hexyl 2-butenoate, Berryflor, Tetrahydrofurfuryl propranonate, Isobutyl phenylacetate, Ethyl valerate, Ethyl cinnamate, Pivarose Q, Isoamyl angelate, Dihydrocarveol acetate, Methyl octine carbonate, Ethyl butanoate, Acetarolle, Flor acetate, Diethyl malonate, beta-Terpinyl acetate, Methyl 2-octynoate, Neofolione, Methyl cinnamate, Sclareolate, Butyl 10-undecenoate, cyclobutanate, Butyl butyryl lactate, Romascone, Nirvanolide, Phenirat, Herbaflorat, Isoambrettolide, Ethyl beta-safranate, Cis-iso-ambrettolide, Ethyl 3-hydroxybutyrate, 8-Hexadecenolide, trans-ambrettolide, Cyclaprop, Triacetin, Isoamyl undecylenate, Ethyl undecylenate, Fragolane, Citronellyl isobutyrate, Herbanate, Isopentyrate, Allyl cyclohexyl propionate, Habanolide, Methyl cyclopentylideneacetate, Benzyl laurate, Citronellyl caproate, Ethyl alpha-safranate, Myrcenyl acetate, Phenethyl isobutyrate, Ethyl gamma-Safranate, Diacetin, Ethyl tiglate, Fructone, Dimethyl benzyl carbinyl butyrate, Jasmolactone, Phenoxyethyl propionate, 1-Hepten-1-ol, 1-acetate, Citronellyl butyrate, Givescone, Benzyl isovalerate, gamma-Jasmolactone, Methyl alpha-cyclogeranate, Citronellyl propionate, alpha-Terpinyl acetate, 3-Hexenyl isovalerate, Benzyl isobutyrate, Montaverdi, 2-Phenylethyl butyrate, 1-Octen-3-yl acetate, alpha-Terpinyl propionate, Triethyl citrate, Phenylethyl methacrylate, 2-Phenylethyl acetate, Verdural B Extra, 3-hydroxy-4,5-dimethyl-2(5H)-furanone, Gelsone, Allyl heptanoate, Firascone, 2-Phenethyl propionate, cis-3-Hexenyl 2-methylbutyrate, 5-Ethyl-3-hydroxy-4-methyl-2(5H)-furanone, Florex, Methyl phenyl carbinyl propionate, Linalyl octanoate, Allyl caproate, Cinnamyl isobutyrate, Furfuryl octanoate, Benzyl butyrate, Furfuryl heptanoate, Benzyl cinnamate, gamma-Terpinyl acetate, Quincester, Furfuryl hexanoate, Cyclogalbanate, Anisyl acetate, Citronellyl tiglate, Hexenyl tiglate, cis-3-Hexenyl propionate, Methyl dihydrojasmonate, trans-Hedione, Allyl amyl glycolate, Cinnamyl acetate, Cinnamyl cinnamate, Calyxol, Cinnamyl propionate, Dihydro Isojasmonate, Methyl linoleate, alpha-Amylcinnamyl acetate, Benzyl phenylacetate, Aladinate, Anisyl phenylacetate, Ethyl 3-phenylglycidate, 2-Acetoxy-3-butanone, Ethyl 3,7-dimethyl-2,6-octadienoate, Anapear, Methyl geraniate, Hexarose, Allyl phenoxyacetate, Caryophyllene alcohol acetate, (Z)-5-Tangerinol, (E)-5-Tangerinol, Citryl acetate, Myraldyl acetate, Carvyl acetate, Perillyl acetate, Vetivert Acetate, Methyl epijasmonate, Trichloromethyl phenyl carbinyl acetate, Farnesyl acetate, Verdox, Verdox HC, Vertenex, Cyclabute, Frutene, Dimethyl benzyl carbinyl acetate, Styrallyl acetate and mixtures thereof.

Especially stable esters for use in the composition of the invention are selected from the group consisting of isopropyl 2-methylbutyrate, hexyl isobutyrate, hexyl butyrate, ethyl 2 methyl pentanoate, hexyl acetate, hexyl propanoate, ethyl 2-methylbutyrate, butyl butyrate, amyl propionate, ethyl hexanoate, methyl 2-methylbutyrate, ethyl acetate, isoamyl acetoacetate, geranyl acetate, isoamyl acetate, linalyl acetate, ethyl butyrate, citronellyl acetate, benzyl acetate, cis-3-hexenyl acetate, 3-hexenyl acetate, ethyl acetoacetate, neryl acetate, prenyl acetate and mixtures thereof.

Perfumery characters that typically comprise sulphur notes include: i) fruity perfumes such as mango, berry (including cassis, strawberry, blueberry, blackberry, raspberry, redcurrant, blackcurrant, cranberry and cherry), lychee, guava, grape, peach, peach skin, nectarine, apricot and passion fruit; ii) citrus perfumes such as bergamot, neroli and grapefruit; iii) floral perfumes such as lavender and geranium; and iv) green perfumes such as mint, mint leaf, tomato, tomato leaf, tomato vine, sage and clary sage and v) mixtures thereof.

The sulphur-containing perfume components are preferably selected from the group comprising: Oxane, Furfuryl methyl sulphide, Dipropyl sulphide, Dibutyl sulphide, 1,8-Thiocineol, Dimethyl sulphide, p-menth-1-en-8-thiol, Thiomenthone and/or Tropicol.

The perfume of the composition of the invention preferably comprises blooming perfume ingredients and non-blooming perfume ingredients.

A blooming perfume ingredient is characterized by its boiling point (B.P.) and its octanol/water partition coefficient (P). The octanol/water partition coefficient of a perfume ingredient is the ratio between its equilibrium concentrations in octanol and in water. Since the partition coefficients of the preferred perfume ingredients herein have high values, they are more conveniently given in the form of their logarithm to the base 10, log P. The B.P. herein is determined at the normal, standard pressure of 760 mm Hg.

c Log P: The c Log P of a perfume component is determined in accordance with the protocol described in U.S. Pat. No. 6,916,769

### Automatic Dishwashing Detergent Composition

The composition of the invention has a neutral or acid pH. In addition to good cleaning and shine in automatic-dishwashing, this pH is quite gentle on the washed items, it is not as aggressive as commonly used alkaline compositions and therefore keeps washed items such as glasses, patterned ware, etc looking new for longer.

The composition of the invention can be in any physical form including solid, liquid and gel form. The composition of the invention is very well suited to be presented in unit-dose form, in particular in the form of a multi-compartment pack, more in particular a multi-compartment pack comprising compartments with compositions in different physical forms, for example a compartment comprising a composition in solid form and another compartment comprising a composition in liquid form. Due to the efficacy of the composition, the packs can be compact.

It is preferred that the composition of the invention comprises less than 0.1%, preferably less than 0.05%, more preferably less than 0.01% by weight of the composition and preferably is substantially free of an enzyme that has esterase activity from E.C Class 3.1.1.

### Buffer

The benefits provided by the composition of the invention are linked to the low pH of the wash liquor. It is not sufficient to provide a composition presenting a low pH when dissolved in deionised water, what is important is that the low pH of the composition is maintained during the duration of the wash.

In the process of dishwashing, the water and the different ions coming from the soils can destabilise the pH of the composition. In order to maintain the composition at low pH a buffering system capable of maintaining the low pH during the wash is needed. When the composition of the invention is added to water to create a wash liquor the buffer generates a buffering system. A buffering systems can be created either by using a mixture of an acid and its anion, such as a citrate salt and citric acid, or by using a mixture of the acid form (citric acid) with a source of alkalinity (such as a hydroxide, bicarbonate or carbonate salt) or by using the anion (sodium citrate) with a source of acidity (such as sodium bisulphate). Suitable buffering systems comprise mixtures of organic acids and their salts, such as citric acid and citrate.

Preferred buffers for use herein include a polycarboxylic acid, its salts and mixtures thereof, preferably citric acid, citrate and mixtures thereof.

Preferably the composition of the invention comprises from about 1% to about 60%, more preferably from about 10% to about 40% by weight of the composition of a buffer, preferably selected from citric acid, citrate and mixtures thereof.

### Builder

Preferably, the composition of the invention is substantially builder free, i.e. comprises less than about 10%, preferably less than about 5%, more preferably less than about 1% and especially less than about 0.1% of builder by weight of the composition. Builders are materials that sequester hardness ions, particularly calcium and/or magnesium. Strong calcium builders are species that are particularly effective at binding calcium and exhibit strong calcium binding constants, particularly at high pHs.

For the purposes of this patent a “builder” is a strong calcium builder. A strong calcium builder can consist of a builder that when present at 0.5 mM in a solution containing 0.05 mM of Fe(III) and 2.5 mM of Ca(II) will selectively bind the calcium ahead of the iron at one or more of pHs 6.5 or 8 or 10.5. Specifically, the builder when present at 0.5 mM in a solution containing 0.05 mM of Fe(III) and 2.5 mM of Ca(II) will bind less than 50%, preferably less than 25%, more preferably less than 15%, more preferably less than 10%, more preferably less than 5%, more preferably less than 2% and specially less than 1% of the Fe(III) at one or preferably more of pHs 6.5 or 8 as measured at 25° C. The builder will also preferably bind at least 0.25 mM of the calcium, preferably at least 0.3 mM, preferably at least 0.4 mM, preferably at least 0.45 mM, preferably at least 0.49 mM of calcium at one or more of pHs 6.5 or 8 or 10.5 as measured at 25° C.

The most preferred strong calcium builders are those that will bind calcium with a molar ratio (builder:calcium) of less than 2.5:1, preferably less than 2:1, preferably less than 1.5:1 and most preferably as close as possible to 1:1, when equal quantities of calcium and builder are mixed at a concentration of 0.5 mM at one or more of pHs 6.5 or 8 or 10.5 as measured at 25° C.

Examples of strong calcium builders include phosphate salts such as sodium tripolyphosphate, amino acid-based builders such as amino acid based compounds, in particular MGDA (methyl-glycine-diacetic acid), and salts and derivatives thereof, GLDA (glutamic-N,N-diacetic acid) and salts and derivatives thereof, IDS (iminodisuccinic acid) and salts and derivatives thereof, carboxy methyl inulin and salts and derivatives thereof and mixtures thereof.

Other builders include amino acid based compound or a succinate based compound. Other suitable builders are described in U.S. Pat. No. 6,426,229. In one aspect, suitable builders include, for example, aspartic acid-N-monoacetic acid (ASMA), aspartic acid-, -diacetic acid (ASDA), aspartic acid-N-monopropionic acid (ASMP), iminodisuccinic acid (IDA), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methyliminodiacetic acid (MID A), alpha-alanine-N,N-diacetic acid (alpha-ALDA), serine-, -diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N, N-diacetic acid (SLDA), taurine-N, N-diacetic acid (TUDA) and sulfomethyl-N,N-diacetic acid (SMDA) and alkali metal salts or ammonium salts thereof.

Polycarboxylic acids and their salts do not act as builders at the pH of the present invention and therefore are not to be considered as builders within the meaning of the invention. Polycarboxylic acids and their salts are considered a buffer within the meaning of the invention.

### Iron Chelant

The composition of the invention preferably comprises an iron chelant at a level of from about 0.1% to about 5%, preferably from about 0.2% to about 2%, more preferably from about 0.4% to about 1% by weight of the composition.

As commonly understood in the detergent field, chelation herein means the binding or complexation of a bi- or multi-dentate ligand. These ligands, which are often organic compounds, are called chelants, chelators, chelating agents, and/or sequestering agent. Chelating agents form multiple bonds with a single metal ion. Chelants form soluble, complex molecules with certain metal ions, inactivating the ions so that they cannot normally react with other elements or ions to produce precipitates or scale. The ligand forms a chelate complex with the substrate. The term is reserved for complexes in which the metal ion is bound to two or more atoms of the chelant.

The composition of the present invention is preferably substantially free of builders and preferably comprises an iron chelant. An iron chelant has a strong affinity (and high binding constant) for Fe(III).

It is to be understood that chelants are to be distinguished from builders. For example, chelants are exclusively organic and can bind to metals through their N,P,O coordination sites or mixtures thereof while builders can be organic or inorganic and, when organic, generally bind to metals through their O coordination sites. Moreover, the chelants typically bind to transition metals much more strongly than to calcium and magnesium; that is to say, the ratio of their transition metal binding constants to their calcium/magnesium binding constants is very high. By contrast, builders herein exhibit much less selectivity for transition metal binding, the above-defined ratio being generally lower.

The chelant in the composition of the invention is a selective strong iron chelant that will preferentially bind with iron (III) versus calcium in a typical wash environment where calcium will be present in excess versus the iron, by a ratio of at least 10:1, preferably greater than 20:1. The iron chelant when present at 0.5 mM in a solution containing 0.05 mM of Fe(III) and 2.5 mM of Ca(II) will fully bind at least 50%, preferably at least 75%, more preferably at least 85%, more preferably at least 90%, more preferably at least 95%, more preferably at least 98% and specially at least 99% of the Fe(III) at one or preferably more of pHs 6.5 or 8 as measured at 25° C. The amount of Fe(III) and Ca(II) bound by a builder or chelant is determined as explained herein below.

### Method for Determining Competitive Binding

To determine the selective binding of a specific ligand to specific metal ions, such as iron(III) and calcium (II), the binding constants of the metal ion-ligand complex are obtained via reference tables if available, otherwise they are determined experimentally. A speciation modeling simulation can then be performed to quantitatively determine what metal ion-ligand complex will result under a specific set of conditions.

As used herein, the term “binding constant” is a measurement of the equilibrium state of binding, such as binding between a metal ion and a ligand to form a complex. The binding constant K_{bc} (25° C. and an ionic strength (I) of 0.1 mol/L) is calculated using the following equation:

K_{bc}=[MLₓ]/([M][L]^{x})

where [L] is the concentration of ligand in mol/L, x is the number of ligands that bond to the metal, [M] is the concentration of metal ion in mol/L, and [MLₓ] is the concentration of the metal/ligand complex in mol/L.

Specific values of binding constants are obtained from the public database of the National Institute of Standards and Technology (“NIST”), R. M. Smith, and A. E. Martell, NIST Standard Reference Database 46, NIST Critically Selected Stability Constants of Metal Complexes: Version 8.0, May 2004, U.S. Department of Commerce, Technology Administration, NIST, Standard Reference Data Program, Gaithersburg, Md. If the binding constants for a specific ligand are not available in the database then they are measured experimentally.

Once the appropriate binding constants have been obtained, a speciation modeling simulation can be performed to quantitatively determine what metal ion-ligand complex will result under a specific set of conditions including ligand concentrations, metal ion concentrations, pH, temperature and ionic strength. For simulation purposes, NIST values at 25° C. and an ionic strength (I) of 0.1 mol/L with sodium as the background electrolyte are used. If no value is listed in NIST the value is measured experimentally. PHREEQC from the US Geological Survey, http://wwwbrr.cr.usgs.gov/projects/GWC_coupled/phreeqc/. PHREEQC is used for speciation modeling simulation.

Iron chelants include those selected from siderophores, catechols, enterobactin, hydroxamates and hydroxypyridinones or hydroxypyridine N-Oxides. Preferred chelants include anionic catechols, particularly catechol sulphonates, hydroxamates and hydroxypyridine N-Oxides. Preferred strong chelants include hydroxypridine N-Oxide (HPNO), Octopirox, and/or Tiron (disodium 4,5-dihydroxy-1,3-benzenedisulfonate), with Tiron, HPNO and mixtures thereof as the most preferred for use in the composition of the invention. HPNO within the context of this invention can be substituted or unsubstituted. Numerous potential and actual resonance structures and tautomers can exist. It is to be understood that a particular structure includes all of the reasonable resonance structures and tautomers.

### Bleach

The composition of the invention preferably comprises less than about 30% bleach, more preferably less than 20% and especially from about 1 to about 5% bleach by weight of the composition.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

Preferably, the level of bleach in the composition of the invention is from about 0 to about 10%, more preferably from about 0.1 to about 5%, even more preferably from about 0.5 to about 3% by weight of the composition.

### Crystal Growth Inhibitor

Crystal growth inhibitors are materials that can bind to calcium carbonate crystals and prevent further growth of species such as aragonite and calcite.

Examples of effective crystal growth inhibitors include phosphonates, polyphosphonates, inulin derivatives and cyclic polycarboxylates.

Suitable crystal growth inhibitors may be selected from the group comprising HEDP (1-hydroxyethylidene 1,1-diphosphonic acid), carboxymethylinulin (CMI), tricarballylic acid and cyclic carboxylates. For the purposes of this invention the term carboxylate covers both the anionic form and the protonated carboxylic acid form.

Cyclic carboxylates contain at least two, preferably three or preferably at least four carboxylate groups and the cyclic structure is based on either a mono- or bi-cyclic alkane or a heterocycle. Suitable cyclic structures include cyclopropane, cyclobutane, cyclohexane or cyclopentane or cycloheptane, bicyclo-heptane or bicyclo-octane and/or tetrahydrofuran. One preferred crystal growth inhibitor is cyclopentane tetracarboxylate.

Cyclic carboxylates having at least 75%, preferably 100% of the carboxylate groups on the same side, or in the “cis” position of the 3D-structure of the cycle are preferred for use herein.

It is preferred that the two carboxylate groups, which are on the same side of the cycle are in directly neighbouring or “ortho” positions

Preferred crystal growth inhibitors include HEDP, tricarballylic acid, tetrahydrofurantetracarboxylic acid (THFTCA) and cyclopentanetetracarboxylic acid (CPTCA). The THFTCA is preferably in the 2c,3t,4t,5c-configuration, and the CPTCA in the cis,cis,cis,cis-configuration.

The crystal growth inhibitors are present preferably in a quantity from about 0.01 to about 10%, particularly from about 0.02 to about 5% and in particular from 0.05 to 3% by weight of the composition.

### Performance Polymer

Preferably the composition of the invention comprises from 0.1% to about 5%, preferably from about 0.2% to about 3% by weight of the composition of a performance polymer. Suitable polymers include alkoxylated polyalkyleneimines, polymeric polycarboxylates, including alkoxylated polycarboxylates, polymers of unsaturated monomeric acids, polyethylene glycols, styrene co-polymers, cellulose sulfate esters, carboxylated polysaccharides, amphiphilic graft copolymers and sulfonated polymers.

The performance polymers may be included to provide benefits in one or more of the areas of spotting and filming, dispersancy, cleaning and bleachable stain cleaning. The performance polymers which provide a dispersancy benefit can also be referred to as dispersing polymers.

A preferred performance polymer for use herein, in terms of enhancing cleaning of bleachable stains is an alkoxylated polyalkyleneimine.

### Alkoxylated Polyalkyleneimine

The alkoxylated polyalkyleneimine has a polyalkyleneimine backbone and alkoxy chains. Preferably the polyalkyleneimine is polyethyleneimine. Preferably, the alkoxylated polyalkyleneimine is not quaternized.

In a preferred alkoxylated polyalkyleneimine for use in the composition of the invention:
i) the polyalkyleneimine backbone represents from 0.5% to 40%, preferably from 1% to 30% and especially from 2% to 20% by weight of the alkoxylated polyalkyleneimine; and
ii) the alkoxy chains represent from 60% to 99%, preferably from 50% to about 95%, more preferably from 60% to 90% by weight of the alkoxylated polyalkyleneimine.

Preferably, the alkoxy chains have an average of from about 1 to about 50, more preferably from about 2 to about 40, more preferably from about 3 to about 30 and especially from about 3 to about 20 and even more especially from about 4 to about 15 alkoxy units preferably ethoxy units. In other suitable polyalkyleneimine for use herein, the alkoxy chains have an average of from about 0 to 30, more preferably from about 1 to about 12, especially from about 1 to about 10 and even more especially from about 1 to about 8 propoxy units. Especially preferred are alkoxylated polyethyleneimines wherein the alkoxy chains comprise a combination of ethoxy and propoxy chains, in particular polyethyleneimines comprising chains of from 4 to 20 ethoxy units and from 0 to 6 propoxy units.

Preferably, the alkoxylated polyalkyleneimine is obtained from alkoxylation wherein the starting polyalkyleneimine has a weight-average molecular weight of from about 100 to about 60,000, preferably from about 200 to about 40,000, more preferably from about 300 to about 10,000 g/mol. A preferred example is 600 g/mol polyethyleneimine core ethoxylated to 20 EO groups per NH and is available from BASF.

Other suitable polyalkyleneimines for use herein includes compounds having the following general structure: bis((C₂H₅O)(C₂H₄O)ₙ)(CH₃)—N⁺—CₓH₂ₓ—N⁺—(CH₃)-bis((C₂H₅O)(C₂H₄O)ₙ), wherein n=from 20 to 30, and x=from 3 to 8, or sulphated or sulphonated variants thereof.

### Polycarboxylates

For example, a wide variety of modified or unmodified polyacrylates, polyacrylate/maleates, or polyacrylate/methacrylates are highly useful. It is believed, though it is not intended to be limited by theory, that these performance polymers are excellent dispersing agents and enhance overall detergent performance, particularly when used in combination with buffering agents, by crystal growth inhibition, particulate soil release peptization, and antiredeposition. Examples of polymeric dispersing agents are found in U.S. Pat. No. 3,308,067 and EP 193,360.

Suitable polycarboxylate-based polymers include polycarboxylate polymers that may have average molecular weights of from about 500 Da to about 500,000 Da, or from about 1,000 Da to about 100,000 Da, or even from about 3,000 Da to about 80,000 Da. In one aspect, suitable polycarboxylates may be selected from the group comprising polymers comprising acrylic acid such as Sokalan PA30, PA20, PA15, PA10 and Sokalan CP10 (BASF GmbH, Ludwigshafen, Germany), Acusol™ 45N, 480N, 460N and 820 (sold by Rohm and Haas, Philadelphia, Pa., USA) polyacrylic acids, such as Acusol™ 445 and Acusol™ 420 (sold by Rohm and Haas, Philadelphia, Pa., USA) acrylic/maleic co-polymers, such as Acusol™ 425N and acrylic/methacrylic copolymers Several examples of such polymers are disclosed in WO 95/01416.

Alkoxylated polycarboxylates such as those prepared from polyacrylates are useful herein to and can provide additional grease suspension. Such materials are described in WO 91/08281 and PCT 90/01815. Chemically, these materials comprise polyacrylates having one ethoxy side-chain per every 7-8 acrylate units. The side-chains are ester-linked to the polyacrylate “backbone” to provide a “comb” polymer type structure. The molecular weight can vary, but may be in the range of about 2000 Da to about 50,000 Da.

Dispersant polymers suitable for use herein are further illustrated by the film-forming polymers described in U.S. Pat. No. 4,379,080 (Murphy), issued Apr. 5, 1983.

Other suitable dispersing polymers include those disclosed in U.S. Pat. No. 3,308,067 issued Mar. 7, 1967, to Diehl. Unsaturated monomeric acids that can be polymerized to form suitable dispersing polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than about 50% by weight of the dispersing polymer.

Co-polymers of acrylamide and acrylate having a molecular weight of from about 3,000 Da to about 100,000 Da preferably from about 4,000 Da to about 20,000 Da and an acrylamide content of less than about 50%, preferably less than about 20%, by weight of the dispersing polymer can also be used. Most preferably, such dispersing polymer has a molecular weight of from about 4,000 Da to about 20,000 Da and an acrylamide content of from about 0% to about 15%, by weight of the polymer.

Yet other dispersing polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Other suitable dispersing polymers are the carboxylated polysaccharides, particularly starches, celluloses and alginates, described in U.S. Pat. No. 3,723,322,

Diehl, issued Mar. 27, 1973; the dextrin esters of polycarboxylic acids disclosed in

U.S. Pat. No. 3,929,107, Thompson, issued Nov. 11, 1975; the hydroxyalkyl starch ethers, starch esters, oxidized starches, dextrins and starch hydrolysates described in

U.S. Pat. No. 3,803,285, Jensen, issued Apr. 9, 1974; the carboxylated starches described in U.S. Pat. No. 3,629,121, Eldib, issued Dec. 21, 1971; and the dextrin starches described in U.S. Pat. No. 4,141,841, McDonald, issued Feb. 27, 1979.

Preferred cellulose-derived dispersant polymers are the carboxymethyl celluloses.

Yet another group of acceptable dispersing are the organic dispersing polymers, such as polyaspartates.

### Amphiphilic Graft Co-Polymers

Suitable amphilic graft co-polymer comprises (i) polyethylene glycol backbone; and (ii) and at least one pendant moiety selected from polyvinyl acetate, polyvinyl alcohol and mixtures thereof.

In other examples, the amphilic graft copolymer is Sokalan HP22, supplied from BASF.

### Sulfonated Polymers

Suitable sulfonated/carboxylated polymers described herein may have a weight average molecular weight of less than or equal to about 100,000 Da, preferably less than or equal to about 75,000 Da, more preferably less than or equal to about 50,000 Da, more preferably from about 3,000 Da to about 50,000 Da, and specially from about 5,000 Da to about 45,000 Da.

Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or α-methyl styrene.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas, Versaflex Si™ (sold by Alco Chemical, Tennessee, USA) and those described in U.S. Pat. No. 5,308,532 and in WO 2005/090541. Suitable styrene co-polymers may be selected from the group comprising, styrene co-polymers with acrylic acid and optionally sulphonate groups, having average molecular weights in the range 1,000 Da-50,000 Da, or even 2,000 Da-10,000 Da such as those supplied by Alco Chemical Tennessee, USA, under the tradenames Alcosperse® 729 and 747.

### Non-Ionic Surfactants

Suitable for use herein are non-ionic surfactants, they can act as anti-redeposition agents. Traditionally, non-ionic surfactants have been used in automatic dishwashing for surface modification purposes in particular for sheeting to avoid filming and spotting and to improve shine. It has been found that in the compositions of the invention, where filming and spotting does not seem to be a problem, non-ionic surfactants can contribute to prevent redeposition of soils.

Preferably, the composition comprises a non-ionic surfactant or a non-ionic surfactant system having a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and better finishing properties and stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkylphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R₁O[CH₂CH(CH₃)O]ₓ[CH₂CH₂O]_{y}[CH₂CH(OH)R₂] (I)

wherein R₁ is a linear or branched, aliphatic hydrocarbon radical having from 4 to 18 carbon atoms; R₂ is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I has at least about 10 carbon atoms in the terminal epoxide unit [CH₂CH(OH)R₂]. Suitable surfactants of formula I are Olin Corporation's POLY-TERGENT® SLF-18B nonionic surfactants, as described, for example, in WO 94/22800, published Oct. 13, 1994 by Olin Corporation.

Preferably non-ionic surfactants and/or system to use as anti-redeposition agents herein have a Draves wetting time of less than 360 seconds, preferably less than 200 seconds, more preferably less than 100 seconds and especially less than 60 seconds as measured by the Draves wetting method (standard method ISO 8022 using the following conditions; 3-g hook, 5-g cotton skein, 0.1% by weight aqueous solution at a temperature of 25° C.).

Amine oxides surfactants are also useful in the present invention as anti-redeposition surfactants and include linear and branched compounds having the formula:

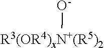

wherein R³ is selected from an alkyl, hydroxyalkyl, acylamidopropoyl and alkyl phenyl group, or mixtures thereof, containing from 8 to 26 carbon atoms, preferably 8 to 18 carbon atoms; R⁴ is an alkylene or hydroxyalkylene group containing from 2 to 3 carbon atoms, preferably 2 carbon atoms, or mixtures thereof; x is from 0 to 5, preferably from 0 to 3; and each R⁵ is an alkyl or hydroxyalkyl group containing from 1 to 3, preferably from 1 to 2 carbon atoms, or a polyethylene oxide group containing from 1 to 3, preferably 1, ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₈ alkoxy ethyl dihydroxyethyl amine oxides. Examples of such materials include dimethyloctylamine oxide, diethyldecylamine oxide, bis-(2-hydroxyethyl)dodecylamine oxide, dimethyldodecylamine oxide, dipropyltetradecylamine oxide, methylethylhexadecylamine oxide, dodecylamidopropyl dimethylamine oxide, cetyl dimethylamine oxide, stearyl dimethylamine oxide, tallow dimethylamine oxide and dimethyl-2-hydroxyoctadecylamine oxide. Preferred are C₁₀-C₁₈ alkyl dimethylamine oxide, and C₁₀₋₁₈ acylamido alkyl dimethylamine oxide.

Non-ionic surfactants may be present in amounts from 0 to 10%, preferably from 0.1% to 10%, and most preferably from 0.25% to 6% by weight of the composition.

### Anionic Surfactant

Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C8-C 22 alkyl, or acyl group. Such surfactants are employed in the form of water-soluble salts and the salt-forming cation usually is selected from sodium, potassium, ammonium, magnesium and mono-, di- or tri-alkanolammonium, with the sodium cation being the usual one chosen.

The anionic surfactant can be a single surfactant or a mixture of anionic surfactants. Preferably the anionic surfactant comprises a sulphate surfactant, more preferably a sulphate surfactant selected from the group consisting of alkyl sulphate, alkyl alkoxy sulphate and mixtures thereof. Preferred alkyl alkoxy sulphates for use herein are alkyl ethoxy sulphates.

### Alkyl Ether Sulphate (AES) Surfactants

The alkyl ether sulphate surfactant has the general formula (I)

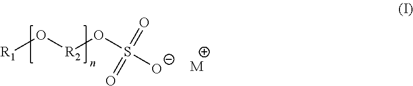

having an average alkoxylation degree (n) of from about 0.1 to about 8, 0.2 to about 5, even more preferably from about 0.3 to about 4, even more preferably from about 0.8 to about 3.5 and especially from about 1 to about 3.

The alkoxy group (R₂) could be selected from ethoxy, propoxy, butoxy or even higher alkoxy groups and mixtures thereof. Preferably, the alkoxy group is ethoxy. When the alkyl ether sulphate surfactant is a mixture of surfactants, the alkoxylation degree is the weight average alkoxylation degree of all the components of the mixture (weight average alkoxylation degree).

In the weight average alkoxylation degree calculation the weight of alkyl ether sulphate surfactant components not having alkoxylated groups should also be included.

Weight average alkoxylation degree n=(x1*alkoxylation degree of surfactant 1+x2*alkoxylation degree of surfactant 2+ . . . )/(x1+x2+ . . . )

wherein x1, x2, are the weights in grams of each alkyl ether sulphate surfactant of the mixture and alkoxylation degree is the number of alkoxy groups in each alkyl ether sulphate surfactant.

The hydrophobic alkyl group (R₁) can be linear or branched. Most suitably the alkyl ether sulphate surfactant to be used in the detergent of the present invention is a branched alkyl ether sulphate surfactant having a level of branching of from about 5% to about 40%, preferably from about 10% to about 35% and more preferably from about 20% to about 30%. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the alkyl ether sulphate surfactant used in the detergent of the invention.

The branched alkyl ether sulphate surfactant can be a single sulphate surfactant or a mixture of sulphate surfactants. In the case of a single sulphate surfactant the percentage of branching refers to the weight percentage of the hydrocarbyl chains that are branched in the original alcohol from which the sulphate surfactant is derived.

In the case of a sulphate surfactant mixture the percentage of branching is the weight average and it is defined according to the following formula:

Weight average of branching (%)=[(x1*wt % branched alcohol 1 in alcohol 1+x2*wt % branched alcohol 2 in alcohol 2+ . . . )/(x1+x2+ . . . )]*100

wherein x1, x2, are the weight in grams of each alcohol in the total alcohol mixture of the alcohols which were used as starting material for the AES surfactant for the detergent of the invention. In the weight average branching degree calculation the weight of AES surfactant components not having branched groups should also be included.

Preferably the anionic surfactant of this invention is not purely based on a linear alcohol, but has some alcohol content that contains a degree of branching. Without wishing to be bound by theory it is believed that branched surfactant drives stronger starch cleaning, particularly when used in combination with an α-amylase, based on its surface packing.

Alkyl ether sulphates are commercially available with a variety of chain lengths, ethoxylation and branching degrees, examples are those based on Neodol alcohols ex the Shell company, Lial-Isalchem and Safol ex the Sasol company, natural alcohols ex The Procter & Gamble Chemicals Company.

Preferably, the alkyl ether sulfate is present from about 0.05% to about 20%, preferably from about 0.1% to about 8%, more preferably from about 1% to about 6%, and most preferably from about 2% to about 5% by weight of the composition.

### Suds Suppressor

Suds suppressors suitable for use herein include an alkyl phosphate ester suds suppressor, a silicone suds suppressor, or combinations thereof. Suds suppressor technology and other defoaming agents useful herein are documented in “Defoaming, Theory and Industrial Applications,” Ed., P. R. Garrett, Marcel Dekker, N.Y., 1973, incorporated herein by reference. Suds suppressors are preferably included in the composition of the invention, especially when the composition comprises anionic surfactant. The suds suppressor is included in the composition at a level of from about 0.0001% to about 10%, preferably from about 0.001% to about 5%, more preferably from about 0.01% to about 1.5% and especially from about 0.01% to about 0.5%, by weight of the composition.

A preferred suds suppressor is a silicone based suds suppressor. Silicone suds suppressor technology and other defoaming agents useful herein are extensively documented in “Defoaming, Theory and Industrial Applications”, Ed., P. R. Garrett, Marcel Dekker, N.Y., 1973, ISBN 0-8247-8770-6, incorporated herein by reference. See especially the chapters entitled “Foam control in Detergent Products” (Ferch et al) and “Surfactant Antifoams” (Blease et al). See also U.S. Pat. Nos. 3,933,672 and 4,136,045. A preferred silicone based suds suppressors is polydimethylsiloxanes having trimethylsilyl, or alternate end blocking units as the silicone. These may be compounded with silica and/or with surface-active non-silicon components, as illustrated by a suds suppressor comprising 12% silicone/silica, 18% stearyl alcohol and 70% starch in granular form. A suitable commercial source of the silicone active compounds is Dow Corning Corp. Silicone based suds suppressors are useful in that the silica works well to suppress the foam generated by the soils and surfactant

Another suitable silicone based suds suppressor comprises solid silica, a silicone fluid or a silicone resin. The silicone based suds suppressor can be in the form of a granule or a liquid.

Another silicone based suds suppressor comprises dimethylpolysiloxane, a hydrophilic polysiloxane compound having polyethylenoxy-propylenoxy group in the side chain, and a micro-powdery silica.

A phosphate ester suds suppressor may also be used. Suitable alkyl phosphate esters contain from 16-20 carbon atoms. Such phosphate ester suds suppressors may be monostearyl acid phosphate or monooleyl acid phosphate or salts thereof, preferably alkali metal salts.

Other suitable suds suppressors are calcium precipitating fatty acid soaps. However, it has been found to avoid the use of simple calcium-precipitating soaps as antifoams in the present composition as they tend to deposit on dishware. Indeed, fatty acid based soaps are not entirely free of such problems and the formulator will generally choose to minimize the content of potentially depositing antifoams in the instant composition.

Preferably the composition of the invention comprises enzymes, more preferably amylases and proteases.

### Enzyme-Related Terminology

### Nomenclature for Amino Acid Modifications

In describing enzyme variants herein, the following nomenclature is used for ease of reference:
Original amino acid(s):position(s):substituted amino acid(s).

According to this nomenclature, for instance the substitution of glutamic acid for glycine in position 195 is shown as G195E. A deletion of glycine in the same position is shown as G195*, and insertion of an additional amino acid residue such as lysine is shown as G195GK. Where a specific enzyme contains a “deletion” in comparison with other enzyme and an insertion is made in such a position this is indicated as *36D for insertion of an aspartic acid in position 36. Multiple mutations are separated by pluses, i.e.: S99G+V102N, representing mutations in positions 99 and 102 substituting serine and valine for glycine and asparagine, respectively. Where the amino acid in a position (e.g. 102) may be substituted by another amino acid selected from a group of amino acids, e.g. the group consisting of N and I, this will be indicated by V102N/I.

In all cases, the accepted IUPAC single letter or triple letter amino acid abbreviation is employed.

Where multiple mutations are employed they are shown with either using a “+” or a “/”, so for instance either S126C+P127R+S128D or S126C/P127R/S128D would indicate the specific mutations shown are present in each of positions 126, 127 and 128.

### Amino Acid Identity

The relatedness between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

The degree of identity between an amino acid sequence of an enzyme used herein (“invention sequence”) and a different amino acid sequence (“foreign sequence”) is calculated as the number of exact matches in an alignment of the two sequences, divided by the length of the “invention sequence” or the length of the “foreign sequence”, whichever is the shortest. The result is expressed in percent identity. An exact match occurs when the “invention sequence” and the “foreign sequence” have identical amino acid residues in the same positions of the overlap. The length of a sequence is the number of amino acid residues in the sequence.

### Protease

Preferred proteases for use herein have an isoelectric point of from about 4 to about 9, preferably from about 4 to about 8, most preferably from about 4.5 to about 6.5. Proteases with this isoelectric point present good activity in the wash liquor provided by the composition of the invention. As used herein, the term “isoelectric point” refers to electrochemical properties of an enzyme such that the enzyme has a net charge of zero as calculated by the method described below.

Preferably the protease of the composition of the invention is an endoprotease, by “endoprotease” is herein understood a protease that breaks peptide bonds of non-terminal amino acids, in contrast with exoproteases that break peptide bonds from their end-pieces.

### Isoelectric Point

The isoelectric point (referred to as IEP or pI) of an enzyme as used herein refers to the theoretical isoelectric point as measured according to the online pI tool available from ExPASy server at the following web address:

http://web.expasy.org/compute_pi/

The method used on this site is described in the below reference:
Gasteiger E., Hoogland C., Gattiker A., Duvaud S., Wilkins M. R., Appel R. D., Bairoch A.; Protein Identification and Analysis Tools on the ExPASy Server;
(In) John M. Walker (ed): The Proteomics Protocols Handbook, Humana Press (2005).

Preferred proteases for use herein are selected from the group consisting of a metalloprotease, a cysteine protease, a neutral serine protease, an aspartate protease and mixtures thereof.

### Metalloproteases

Metalloproteases can be derived from animals, plants, bacteria or fungi. Suitable metalloprotease can be selected from the group of neutral metalloproteases and Myxobacter metalloproteases. Suitable metalloproteases can include collagenases, hemorrhagic toxins from snake venoms and thermolysin from bacteria. Preferred thermolysin enzyme variants include an M4 peptidase, more preferably the thermolysin enzyme variant is a member of the PepSY˜Peptidase_M4˜Peptidase_M4_C family.

Preferred metalloproteases include thermolysin, matrix metalloproteinases and those metalloproteases derived from Bacillus subtilis, Bacillus thermoproteolyticus, Geobacillus stearothermophilus or Geobacillus sp., or Bacillus amyloliquefaciens, as described in US PA 2008/0293610A1. A specially preferred metalloprotease belongs to the family EC3.4.24.27.

Further suitable metalloproteases are the thermolysin variants described in WO2014/71410. In one aspect the metalloprotease is a variant of a parent protease, said parent protease having at least 50% or 60%, or 80%, or 85% or 90% or 95% or 96% or 97% or 98% or 99% or even 100% identity to SEQ ID NO: 3 of WO 2014/071410 including those with substitutions at one or more of the following sets of positions versus SEQ ID NO: 3 of WO 2014/071410:
(a) 2, 26, 47, 53, 87, 91, 96, 108, 118, 154, 179, 197, 198, 199, 209, 211, 217, 219, 225, 232, 256, 257, 259, 261, 265, 267, 272, 276, 277, 286, 289, 290, 293, 295, 298, 299, 300, 301, 303, 305, 308, 311 and 316;
(b) 1, 4, 17, 25, 40, 45, 56, 58, 61, 74, 86, 97, 101, 109, 149, 150, 158, 159, 172, 181, 214, 216, 218, 221, 222, 224, 250, 253, 254, 258, 263, 264, 266, 268, 271, 273, 275, 278, 279, 280, 282, 283, 287, 288, 291, 297, 302, 304, 307 and 312;
(c) 5, 9, 11, 19, 27, 31, 33, 37, 46, 64, 73, 76, 79, 80, 85, 89, 95, 98, 99, 107, 127, 129, 131, 137, 141, 145, 148, 151, 152, 155, 156, 160, 161, 164, 168, 171, 176, 180, 182, 187, 188, 205, 206, 207, 210, 212, 213, 220, 227, 234, 235, 236, 237, 242, 244, 246, 248, 249, 252, 255, 270, 274, 284, 294, 296, 306, 309, 310, 313, 314 and 315;
(d) 3, 6, 7, 20, 23, 24, 44, 48, 50, 57, 63, 72, 75, 81, 92, 93, 94, 100, 102, 103, 104, 110, 117, 120, 134, 135, 136, 140, 144, 153, 173, 174, 175, 178, 183, 185, 189, 193, 201, 223, 230, 238, 239, 241, 247, 251, 260, 262, 269, and 285;
(e) 17, 19, 24, 25, 31, 33, 40, 48, 73, 79, 80, 81, 85, 86, 89, 94, 109, 117, 140, 141, 150, 152, 153, 158, 159, 160, 161, 168, 171, 174, 175, 176, 178, 180, 181, 182, 183, 189, 205, 206, 207, 210, 212, 213, 214, 218, 223, 224, 227, 235, 236, 237, 238, 239, 241, 244, 246, 248, 249, 250, 251, 252, 253, 254, 255, 258, 259, 260, 261, 262, 266, 268, 269, 270, 271, 272, 273, 274, 276, 278, 279, 280, 282, 283, 294, 295, 296, 297, 300, 302, 306, 310 and 312;
(f) 1, 2, 127, 128, 180, 181, 195, 196, 197, 198, 199, 211, 223, 224, 298, 299, 300, and 316 all relative to SEQ ID NO: 3 of WO 2014/071410.

Further suitable metalloproteases are the NprE variants described in WO2007/044993, WO2009/058661 and US 2014/0315775. In one aspect the protease is a variant of a parent protease, said parent protease having at least 45%, or 60%, or 80%, or 85% or 90% or 95% or 96% or 97% or 98% or 99% or even 100% identity to SEQ ID NO:3 of US 2014/0315775 including those with substitutions at one or more of the following sets of positions versus said sequence:
S23, Q45, T59, S66, S129, F130, M138, V190, S199, D220, K211, and G222,

Another suitable metalloprotease is a variant of a parent protease, said parent protease having at least 60%, or 80%, or 85% or 90% or 95% or 96% or 97% or 98% or 99% or even 100% identity to SEQ ID NO:3 of US 2014/0315775 including those with substitutions at one or more of the following sets of positions versus SEQ ID NO:3 of US 2014/0315775:

Q45E, T59P, S66E, S129I, S129V, F130L, M1381, V190I, S199E, D220P, D220E, K211V, K214Q, G222C, M138L/D220P, F130L/D220P, S129I/D220P, V190I/D220P, M138L/V190I/D220P, S129I/V190I, S129V/V190I, S129V/D220P, S129I/F130L/D220P, T004V/S023N, T059K/S66Q/S129I, T059R/S66N/S129I, S129I/F130L/M138L/V190I/D220P and T059K/S66Q/S129V.

Especially preferred metalloproteases for use herein belong to EC classes EC 3.4.22 or EC3.4.24, more preferably they belong to EC classes EC3.4.22.2, EC3.4.24.28 or EC3.4.24.27. The most preferred metalloprotease for use herein belong to EC3.4.24.27.

Suitable commercially available metalloprotease enzymes include those sold under the trade names Neutrase® by Novozymes A/S (Denmark), the Corolase® range including Corolase® 2TS, Corolase® N, Corolase® L10, Corolase® LAP and Corolase® 7089 from AB Enzymes, Protex 14L and Protex 15L from DuPont (Palo Alto, Calif.), those sold as thermolysin from Sigma and the Thermoase range (PC10F and C100) and thermolysin enzyme from Amano enzymes.

The composition of the invention preferably comprises from 0.001 to 2%, more preferably from 0.003 to 1%, more preferably from 0.007 to 0.3% and especially from 0.01 to 0.1% by weight of the composition of active protease.

### Amylase

Amylases for use herein are preferably low temperature amylases. Compositions comprising low temperature amylases allow for a more energy efficient dishwashing processes without compromising in cleaning.

As used herein, “low temperature amylase” is an amylase that demonstrates at least 1.2, preferably at least 1.5 and more preferably at least 2 times the relative activity of the reference amylase at 25° C. As used herein, the “reference amylase” is the wild-type amylase of Bacillus licheniformis, commercially available under the tradename of Termamyl™ (Novozymes A/S).

As used herein, “relative activity” is the fraction derived from dividing the activity of the enzyme at the temperature assayed versus its activity at its optimal temperature measured at a pH of 9.

Amylases include, for example, α-amylases obtained from Bacillus. Amylases of this invention preferably display some α-amylase activity. Preferably said amylases belong to EC Class 3.2.1.1. Amylases for use herein, including chemically or genetically modified mutants (variants), are amylases possessing at least 60%, or 70%, or 80%, or 85%, or 90%, preferably 95%, more preferably 98%, even more preferably 99% and especially 100% identity, with those derived from Bacillus Licheniformis, Bacillus amyloliquefaciens, Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Suitable amylases include those derived from the sp. 707, sp. 722 or AA560 parent wild-types.

Preferred amylases include the variants of a parent amylase, said parent amylase having at least 60%, preferably 80%, more preferably 85%, more preferably 90%, more preferably 95%, more preferably 96%, more preferably 97%, more preferably 98%, more preferably 99% and specially 100% identity to SEQ ID NO:12 of WO2006/002643. The variant amylase preferably further comprises one or more substitutions and/or deletions in the following positions versus SEQ ID NO:12 of WO2006/002643:

9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484 and preferably the variant amylase comprises the deletions in one or both of the 183 and 184 positions.

Preferred amylases comprise one or both deletions in positions equivalent to positions 183 and 184 of SEQ ID NO:12 of WO2006/002643.

Preferred commercially available amylases for use herein are STAINZYME®, STAINZYME PLUS®, STAINZYME ULTRA®, EVEREST® and NATALASE® (Novozymes A/S) and RAPIDASE, POWERASE® and the PREFERENZ S® series, including PREFERENZ S100® (DuPont).

The composition of the invention preferably comprises from 0.001 to 2%, more preferably from 0.003 to 1%, more preferably from 0.007 to 0.3% and especially from 0.01 to 0.1% by weight of the composition of active amylase.

### Other Enzymes

Preferably the composition of the invention further comprises one or more enzymes selected from the group consisting of an α-amylase, a β-amylase, a pullulanase, a protease, a lipase, a cellulase, an oxidase, a phospholipase, a perhydrolase, a xylanase, a pectate lyase, a pectinase, a galacturanase, a hemicellulase, a xyloglucanase, a mannanase and a mixture thereof.

### Unit Dose Form

The composition of the invention is suitable to be presented in unit-dose form. Products in unit dose form include tablets, capsules, sachets, pouches, injection moulded containers, etc. Preferred for use herein are tablets and detergents wrapped with a water-soluble film (including wrapped tablets, capsules, sachets, pouches) and injection moulded containers. Preferably the water-soluble film is a polyvinyl alcohol, preferably comprising a bittering agent. The detergent composition of the invention is preferably in the form of a water-soluble multi-compartment pack.

Preferred packs comprise at least two side-by-side compartments superposed onto another compartment. This disposition contributes to the compactness, robustness and strength of the pack and additionally, it minimises the amount of water-soluble packing material required. It only requires three pieces of material to form three compartments. The robustness of the pack allows also for the use of very thin films (less than 150 micron, preferably less than 100 micron) without compromising the physical integrity of the pack. The pack is also very easy to use because the compartments do not need to be folded to be used in machine dispensers of fixed geometry. At least two of the compartments of the pack contain two different compositions. By “different compositions” herein is meant compositions that differ in at least one ingredient.

Preferably, at least one of the compartments contains a solid composition, preferably in powder form and another compartment an aqueous liquid composition, the compositions are preferably in a solid to liquid weight ratio of from about 20:1 to about 1:20, more preferably from about 18:1 to about 2:1 and even more preferably from about 15:1 to about 5:1. This kind of pack is very versatile because it can accommodate compositions having a broad spectrum of values of solid:liquid ratio. Particularly preferred have been found to be pouches having a high solid:liquid ratio because many of the detergent ingredients are most suitable for use in solid form, preferably in powder form. The ratio solid:liquid defined herein refers to the relationship between the weight of all the solid compositions and the weight of all the liquid compositions in the pack.

Preferably the two side-by-side compartments contain liquid compositions, which can be the same but preferably are different and another compartment contains a solid composition, preferably in powder form, more preferably a densified powder. The solid composition contributes to the strength and robustness of the pack.

For dispenser fit reasons the unit dose form products herein preferably have a square or rectangular base and a height of from about 1 to about 5 cm, more preferably from about 1 to about 4 cm. Preferably the weight of the solid composition is from about 5 to about 20 grams, more preferably from about 10 to about 15 grams and the total weight of the liquid compositions is from about 0.5 to about 5 grams, more preferably from about 1.5 to about 4 grams.

In preferred embodiments, at least two of the films which form different compartments have different solubility, under the same conditions, releasing the content of the compositions which they partially or totally envelope at different times.

Controlled release of the ingredients of a multi-compartment pouch can be achieved by modifying the thickness of the film and/or the solubility of the film material. The solubility of the film material can be delayed by for example cross-linking the film as described in WO 02/102,955 at pages 17 and 18. Other water-soluble films designed for rinse release are described in U.S. Pat. No. 4,765,916 and U.S. Pat. No. 4,972,017. Waxy coating (see WO 95/29982) of films can help with rinse release. pH controlled release means are described in WO 04/111178, in particular amino-acetylated polysaccharide having selective degree of acetylation. Other means of obtaining delayed release by multi-compartment pouches with different compartments, where the compartments are made of films having different solubility are taught in WO 02/08380.

Alternatively the dissolution of the liquid compartments can be delayed by modification of the liquid that is contained within the film. Use of anionic surfactants, particularly anionic surfactant mixtures that pass through a highly structured phase (such as hexagonal or lamellar) upon addition of water retards the dissolution of the surfactant containing compartment. In one aspect of this invention, one or more compartments comprise anionic surfactant and their release is delayed versus other compartments.

### Auto-Dosing Delivery Device

The compositions of the invention are extremely useful for dosing elements to be used in an auto-dosing device. The dosing elements comprising the composition of the present invention can be placed into a delivery cartridge as that described in WO 2007/052004 and WO 2007/0833141. The dosing elements can have an elongated shape and set into an array forming a delivery cartridge which is the refill for an auto-dosing dispensing device as described in case WO 2007/051989. The delivery cartridge is to be placed in an auto-dosing delivery device, such as that described in WO 2008/053191.

### Example

Five automatic dishwashing solid compositions (Solid Composition 1 (low pH composition), Solid Compositions 2, 3, 4 and 5 (alkaline compositions)) and three liquid compositions (Liquid compositions 1, 2 and 3) were made as detailed herein below. Perfumes were added to the compositions and the peak intensity of the ester-comprising perfume raw materials (PRMs) within the perfume was evaluated via Gas Chromatography Mass Spectrometry (GCMS).

The tests carried out show the unexpected benefit of superior freshness when a perfume comprising ester-comprising perfume raw materials was used in combination with a low pH dishwashing composition.

Tests were carried out using the following detergent compositions:

| Ingredient | Level (% wt) | |
|---|---|---|
| Solid composition | 1 | 2 |
| Sodium carbonate | 0 | 31 |
| Sodium citrate | 20 | 20 |
| 4,5-Dihydroxy-1,3-benzenedisulfonic acid | 5 | 5 |
| Citric acid | 5 | 5 |
| Sodium 1-hydroxyethyidene-1,1-diphosphonate | 4 | 4 |
| Sodium percarbonate | 3 | 3 |
| Protease (8-10% active) | 2 | 2 |
| Amylase (1.4% active) | 1 | 1 |
| Suds suppressor agglomerate | 1 | 1 |

| | |
|---|---|
| Processing Aids | Balance to 100% |

A 1% by weight solution of solid compositions 1 and 2 in deionized water at room temperature had a pH of 6.5 and 10.5, respectively.

| Ingredient | Level (% wt) | |
|---|---|---|
| Solid composition | 3 | 4 |
| Sodium triphosphate pentabasic | 53 | 59 |
| Sodium carbonate | 18 | 22 |
| Sodium percarbonate | 11 | 9 |
| Acusol ™ 588GF (sulfonated polymer | 8 | 7 |
| supplied by DowChemical) | | |
| Tetraacetylethylenediamine | 4 | 1 |
| Protease (10% active) | 2 | 1 |
| Sodium 1-hydroxyethyidene-1,1-diphosphonate | 1 | 0.5 |
| Amylase (1.4% active) | 1 | 1 |
| Zinc containing particle | 1 | 0.5 |
| Processing Aids | Balance to | Balance to |
| | 100% | 100% |

A 1% by weight solution of compositions 3 and 4 in deionized water at room temperature had a pH of 10.5

| Ingredient | Level (% wt) |
|---|---|
| Solid composition | 5 |
| Sodium carbonate | 42 |
| Sodium sulphate | 31 |
| Trilon ® M | 7 |
| Sodium percarbonate | 6 |
| Acusol ™ 588GF (sulfonated polymer supplied by | 4 |
| DowChemical) | |
| Substituted acrylic acid maleic anhydride copolymer | 3 |
| Protease (10% active) | 1 |
| Amylase (1.4% active) | 1 |
| Sodium silicate | 1 |
| Zinc containing particle | 0.5 |
| Processing Aids | Balance to |
| | 100% |

A 1% by weight solution of composition 5 in deionized water at room temperature had a pH of 10.5

| | |
|---|---|
| Ingredient | Level (% wt) |

| Liquid composition | 1 | 2 | 3 |
|---|---|---|---|
| Sodium C₁₂₋₁₄ alkyl ethoxy 3 sulfate | 27 | 0 | 0 |
| (70% active) | | | |
| Lutensol ® TO 7 (non-ionic surfactant | 19 | 41 | 34 |
| supplied by BASF) | | | |
| Plurafac ® SLF180 (non-ionic surfactant | 16 | 34 | 28 |
| supplied by BASF) | | | |
| Lutensol ® FP 620 | 10 | 0 | 9 |
| Glycerine | 15 | 1 | 11 |
| Di propylene glycol | 8 | 18 | 16 |

| | |
|---|---|
| Processing Aids | Balance to 100% |

The detergent compositions above contain no perfume materials—for the example below, perfume was added to these formulations as described.

One dose of detergent, comprising 16 g of the solid composition 1, 16 g of the solid composition 2, 17 g of the solid composition 3, 16 g of the solid composition 4 or 18 g of the solid composition 5 and in all cases with 2.2 g of the liquid composition 1 or 2, and the perfume, was added to 5 L of city water, 6.8 gpg at 50° C.

| Example | Composition |
|---|---|
| Formula A | Powder composition 3 + Liquid composition 2 + 0.1 g |
| | Perfume 1. |
| Formula B | Powder composition 1 + Liquid composition 1 + 0.1 g |
| | Perfume 1. |
| Formula C | Powder composition 2 + Liquid composition 1 + 0.1 g |
| | Perfume 1. |
| Formula D | Powder composition 1 + Liquid composition 1 + 0.1 g |
| | Perfume 2. |
| Formula E | Powder composition 2 + Liquid composition 1 + 0.1 g |
| | Perfume 2. |
| Formula F | Powder composition 4 + Liquid composition 2 + 0.1 g |
| | Perfume 3. |
| Formula G | Powder composition 1 + Liquid composition 2 + 0.1 g |
| | Perfume 3. |
| Formula H | Powder composition 2 + Liquid composition 2 + 0.1 g |
| | Perfume 3. |
| Formula I | Powder composition 5 + Liquid composition 2 + 0.1 g |
| | Perfume 4. |
| Formula J | Powder composition 1 + Liquid composition 2 + 0.1 g |
| | Perfume 4. |
| Formula K | Powder composition 2 + Liquid composition 2 + 0.1 g |
| | Perfume 4. |

Perfume 1: comprises 40% by weight of the perfume of ester-comprising perfume raw materials.

Perfume 2: comprises 8% by weight of the perfume of ester-comprising perfume raw materials.

Perfume 3: comprises 14.6% by weight of the perfume of ester-comprising perfume raw materials.

Perfume 4: comprises 14.6% by weight of the perfume of ester-comprising perfume raw materials.

A 5 g sample of the detergent solution for each formula was added to a standard GCMS vial and placed into an oven set at 50° C. for two hours. This was repeated to give four samples for each formula. The headspace generated in the GCMS vial was samples using a 50/30 um DVB/Carbosen/PDMS Solid Phase Micro Extraction (SPME) fibre and qualitative analysis performed by fast GC and MS. The headspace response for the compositions outside of this invention (Formulas A, C, E, F, H, I or K) is represented as a ratio of the headspace response for this invention (Formulas B, D, G or J).

Headspace Response Ratio versus Formula B, D, G or J

| | Perfume 1 | Perfume 2 | Perfume 3 | Perfume 4 | RSD (%) |
|---|---|---|---|---|---|
| Formula A | 67.3 | — | — | — | 10 |
| Formula B | 100 | — | — | — | 10 |
| Formula C | 72.1 | — | — | — | 10 |
| Formula D | — | 100 | — | — | 10 |
| Formula E | — | 41.6 | — | — | 30 |
| Formula F | — | — | 39.9 | — | 5 |
| Formula G | — | — | 100 | — | 9 |
| Formula H | — | — | 51 | — | 3 |
| Formula I | — | — | — | 48.7 | 2 |
| Formula J | — | — | — | 100 | 8 |
| Formula K | — | — | — | 48.4 | 5 |

As can be seen, a high pH, high sodium percarbonate product (Formulas A, F and I) or a high pH product alone (Formulas C, E, H and K) result in a lower headspace response which will result in a loss of freshness. The compositions of this invention (Formulas B, D, G and J) have a significantly higher headspace response giving superior freshness than the compositions that fall outside of the scope of the invention (Formulas A, C, E, F, H, I and K).

### Cleaning Performance Test

I. Test Stains
   The test stains used were 6.5 cm×10 cm melamine tiles soiled with the following:

| CFT reference | Soil |
|---|---|
| DM21 | Single application egg yolk |
| DM91 | Single application minced meat |
| DM92 | Double application minced meat |
| DM06 | Single application baked cheese |
| DM277 | Double application mixed starch |
| DM376 | Triple application corn starch |

Supplied by the Centre for Test materials (CFT), Vlaardingen, The Netherlands.
II. Additional Ballast Soil 1
To add extra soil stress to the test, a blend of soils is added to the dishwasher, as prepared by the procedure described below

| Ingredient | % content |
|---|---|
| Potato Starch | 5.6 |
| Wheat Flour | 4.5 |
| Vegetable oil | 4.4 |
| Margarine | 4.4 |
| Lard | 4.4 |
| Single Cream | 9.0 |
| Baking Spread | 4.4 |
| Large Eggs | 9.0 |
| Whole Milk | 9.0 |
| Ketchup | 3.0 |
| Mustard | 4.0 |
| Benzoic acid >99% | 0.8 |
| Water (15-18 grains per US | 37.5 |
| gallon) | |
| Total | 100 |

Soil Preparation
1. Add water to the potato starch and leave to soak overnight. Then heat in a pan until the gel formed is properly inflated. Leave the pan to cool at room temperature overnight.
2. Weigh out the appropriate amounts of each ingredient.
3. Add the Ketchup and mustard to a bowl and mix vigorously until fully combined, 1 minute.
4. Melt Margarine, lard and baking spread individually in a microwave and allow to cool to room temperature then mix together.
5. Add Wheat Flour and Benzoic acid to a bowl and mix vigorously.
6. Break eggs into a bowl and mix vigorously.
7. Add vegetable oil to the eggs and stir using a hand blender.
8. Mix the cream and milk in a bowl.
9. Add all of the ingredients together into a large container and mix using a blender for ten minutes.
10. Weigh out 50 g batches of this mixture into plastic pots and freeze.

Test wash procedure
Automatic Dishwasher: Miele, model GSL
Wash volume: 5000 ml
Water temperature: 45° C.
Water hardness: 7.2 US gpg
Detergent addition: Added into the bottom of the automatic dishwasher after the initial pre-wash is complete.
Additional ballast bottom rack: 11× dinner plates
   6× side plates
   1× rectangular glass dish
Positioning of CFT tiles: On top rack, secured into place using pegs.
Additional soil stress: 2×50 g pots of Additional ballast soil 1 added to bottom rack.

### Example

One dose of detergent, comprising 16 g of the powder compositions 4 and 1 respectively, and in both cases with 2.2 g of the liquid composition 2, was added to the automatic dishwasher.

| Example | Composition |
|---|---|
| Formula F | Powder composition 4 + Liquid composition 2 + 0.1 g |
| | Perfume 3. |
| Formula L | Powder composition 1 + Liquid composition 3 + 0.1 g |
| | Perfume 3. |

| | |
|---|---|
| Soils | SRI (soil removal index) |

| CFT | Name | Formula F | Formula L |
|---|---|---|---|
| DM21 | Single egg | 15.0 | 9.9 |
| DM91 | Single Minced meat | 47.7 | 62.4 |
| DM92 | Double minced meat | 32.9 | 33.4 |
| DM06 | single baked cheese | 38.2 | 68.7 |
| DM277 | double mixed starch | 56.2 | 75.6 |
| DM376 | triple corn starch | 55.3 | 71.5 |
| Average | Average | 40.9 | 53.6 |

SRI: the higher the better the cleaning is.

As can be seen the low pH formulation of this invention is more effective at cleaning than the high pH formulation that falls outside.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A neutral or acidic automatic dishwashing detergent composition comprising a perfume wherein the perfume comprises at least one ester-comprising perfume raw material having the following formula: 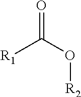
wherein R1 and R2 are independently selected from:
i) unbranched linear alkyls or alkenyls; and
ii) branched linear alkyls or alkenyls wherein if the branching is in an alpha or beta position the branching is CH3 or a pendant cyclic group.

2. A composition according to claim 1 wherein the branching in the branched linear alkyls or alkenyls is a pendant cyclic group.

3. A composition according to claim 1 wherein the ester-comprising perfume raw material is selected from the group consisting of isopropyl 2-methylbutyrate, hexyl isobutyrate, hexyl butyrate, ethyl 2 methyl pentanoate, hexyl acetate, hexyl propanoate, ethyl 2-methylbutyrate, butyl butyrate, amyl propionate, ethyl hexanoate, methyl 2-methylbutyrate, ethyl acetate, isoamyl acetoacetate, geranyl acetate, isoamyl acetate, linalyl acetate, ethyl butyrate, citronellyl acetate, benzyl acetate, cis-3-hexenyl acetate, 3-hexenyl acetate, ethyl acetoacetate, neryl acetate, prenyl acetate and mixtures thereof.

4. A composition according to claim 1 wherein the perfume comprises at least 3%, by weight of the perfume of an ester-comprising perfume raw material.

5. A composition according to claim 1 wherein the perfume comprises at least 5% by weight of the perfume of an ester-comprising perfume raw material.

6. A composition according to claim 1 wherein the perfume comprises a sulphur-comprising perfume raw material preferably selected from the group consisting of oxane, furfuryl methyl sulphide, dipropyl sulphide, dibutyl sulphide, 1,8-thiocineol, dimethyl sulphide, p-menth-1-en-8-thiol, thiomenthone, tropicol and mixtures thereof.

7. A composition according to claim 1 wherein the perfume comprises at least about 10%, more preferably at least about 20% by weight of the perfume of blooming perfume ingredients having a boiling point of less than 260° C. and a C log P of at least 3.

8. A composition according to claim 1 wherein the perfume comprises non-blooming perfume ingredients having a boiling point of more than 260° C. and a C log P of at least 3 and wherein the composition comprises between about 5 to about 20% by weight of the perfume of non-blooming perfume ingredients.

9. A composition according to claim 1 wherein the composition is substantially builder free.

10. A composition according to claim 1 wherein the composition comprises a buffer selected from the group consisting of a polycarboxylic acid, its salt and mixtures thereof.

11. A composition according to claim 1 comprising an iron chelant wherein the iron chelant is selected from the group consisting of siderophores, catechols, enterobactin, hydroxamates, hydroxypyridinones (or hydroxypyridine N-Oxides) and mixtures thereof.

12. A composition according to claim 1 comprising a lime soap dispersing agent.

13. A composition according to claim 1 comprising from about 1% to about 20% by weight of the composition of bleach.

14. A composition according to claim 1 wherein the composition is free of esterases.

15. A composition according to claim 1 having a pH of from about 5.5 to less than about 8 as measured in 1% weight aqueous solution at 25° C.

16. A single or multi-compartment water-soluble pouch comprising a composition according to claim 1.

17. A single or multi-compartment water-soluble pouch comprising a composition according to claim 1 wherein the pouch comprises a compartment comprising a powder composition and a compartment comprising a liquid composition and wherein the liquid composition comprises the perfume.

18. A method of automatic dishwashing comprising the step of delivering into a dishwasher a composition according to claim 1.

19. Use of a composition according to claim 1 to provide freshness in an automatic dishwashing operation wherein the main wash liquor has an acidic or neutral pH.
